(19) United States
(12) Patent Application Publication
(10) Pub. No.: US 2019/0089611 A1
(43) Pub. Date: Mar. 21, 2019

(54) SWITCH HEALTH INDEX FOR NETWORK DEVICES

(71) Applicant: Cisco Technology, Inc., San Jose, CA (US)

(72) Inventors: Satish Kondalam, Milpitas, CA (US); Victor Moreno, Carlsbad, CA (US); Lukas Krattiger, Pleasanton, CA (US)

(21) Appl. No.: 15/710,314

(22) Filed: Sep. 20, 2017

(51) Int. Cl. H04L 12/26; H04L 12/24

(52) U.S. Cl. CPC H04L 43/0817; H04L 43/16; H04L 41/0654; H04L 41/046; H04L 43/0823; H04L 43/14; H04L 43/10

(57) ABSTRACT

Systems and methods are disclosed for determining a distributed health score for an aggregation of network devices. Device health data relevant to a set of key performance indicators is received, and a health score of a first device is determined based at least in part on the set of key performance indicators. The determined health score is then transmitted to at least a second device on the network. A determination of whether to take a corrective action associated with the first device is based on the determined health score.

### TECHNICAL FIELD

The present disclosure pertains to networking, and more specifically to health index calculations of network devices.

### BACKGROUND

Monitoring and troubleshooting devices on a network are typically based on reactive metrics. In such reactive systems, data from a device on a network is communicated, collected, and then sent to external entities that have the required monitoring tools to diagnose, flag, and/or initiate an alert that a device on the network has failed.

These current systems use a pull based model for monitoring network devices. For example, network management systems (NMS) periodically poll network devices via SNMP to gather network device key performance indicators (KPIs). The collected information from various KPI are stored, and from this a health score, health index, indicator, etc. is calculated on a per-device basis. However, when communication between the NMS and a network device is disrupted, the poll is unsuccessful and the data collection cannot be updated. In these situations, depending on how the data is collected and how the health score is calculated, the calculation suffers from a spike (e.g., a degraded health score) and/or no update at all (e.g., a flat health score). Moreover, a static pull based model fails to scale easily, and flounders especially in cloud networking environments as devices dynamically join or leave the network. In addition, intelligence needed to determine an action to take based on data modeling workflows is built into the NMS systems, and NMS is relied upon to take the determined action. Dependency on the NMS to take corrective actions increases due to the dependencies inherent in the pull based model.

Accordingly, mechanisms and/or systems that calculate a device's health score in a manner independent of the connectivity between a respective device and its NMS is needed in order to guarantee fidelity of health scores and enable their use for a variety of purposes, including making routing decisions.

### BRIEF DESCRIPTION OF THE DRAWINGS

The above-recited and other advantages and features of the present technology will become apparent by reference to specific implementations illustrated in the appended drawings. A person of ordinary skill in the art will understand that these drawings only show some examples of the present technology and would not limit the scope of the present technology to these examples. Furthermore, the skilled artisan will appreciate the principles of the present technology as described and explained with additional specificity and detail through the use of the accompanying drawings in which:

FIG. 1 illustrates an example embodiment of an aggregation of network devices that determines one or more distributed health scores;

FIG. 2 illustrates an example embodiment of an agent executing on each of the network devices on a network;

FIG. 3 is a flow chart illustrating a method of determining a distributed health score;

FIG. 4 illustrates an example embodiment of a corrective action;

FIG. 5 is a flow chart illustrating a method of a corrective action; and

FIG. 6 shows an example of a system for implementing certain aspects of the present technology.

### DESCRIPTION OF EXAMPLE EMBODIMENTS

Various examples of the present technology are discussed in detail below. While specific implementations are discussed, it should be understood that this is done for illustration purposes only. A person skilled in the relevant art will recognize that other components and configurations may be used without parting from the spirit and scope of the present technology.

### OVERVIEW

A system, method, and computer readable storage medium is disclosed for determining a distributed health score for an aggregation of network devices. An agent executing on each of the network devices on a network is configured to receive device health data relevant to a set of key performance indicators (KPIs). The agent determines a health score of its respective device based at least in part on the set of KPIs, and enables the determined health score to be made available to at least one other device on the network. Based on the determined health score, it is determined whether to take a corrective action associated with the respective device.

### EXAMPLE EMBODIMENTS

The disclosed technology addresses the need in the art for reliably updating networking device health scores in a manner independent from the connectivity of the network device and its NMS. The systems, methods, and processes described herein utilize a distributed health score calculation, and does so by moving calculations of specific KPIs to the network device itself. Thus, a streaming telemetry based model can be created where the individual network devices are intelligent enough to make decisions, based on one or more KPIs, on their own.

Traffic re-routing decisions can be determined and/or taken locally by switches based on a locally determined health score, termed a switch health indicator (or SHI). The locally determined SHI removes dependencies on connectivity, network disruption, and/or any one device on the network. The present technology also increases reliability of network health compared to standard pull and push based models.

A distributed health score calculation using the SHI increases a network's overall speed, accuracy, bandwidth, and memory. For example, distributed health score calculations allow network devices to exchange the SHI, which acts as a shortened summary of the device health, between network devices and then allows those devices to individually take corrective actions based on one or more SHI thresholds. Exchanging SHIs also improves the fidelity of the health score itself and enables the use of the health score for a variety of purposes, such as making routing decisions, putting a failing device into a maintenance mode, flagging a device with a downward health trend for review, etc.

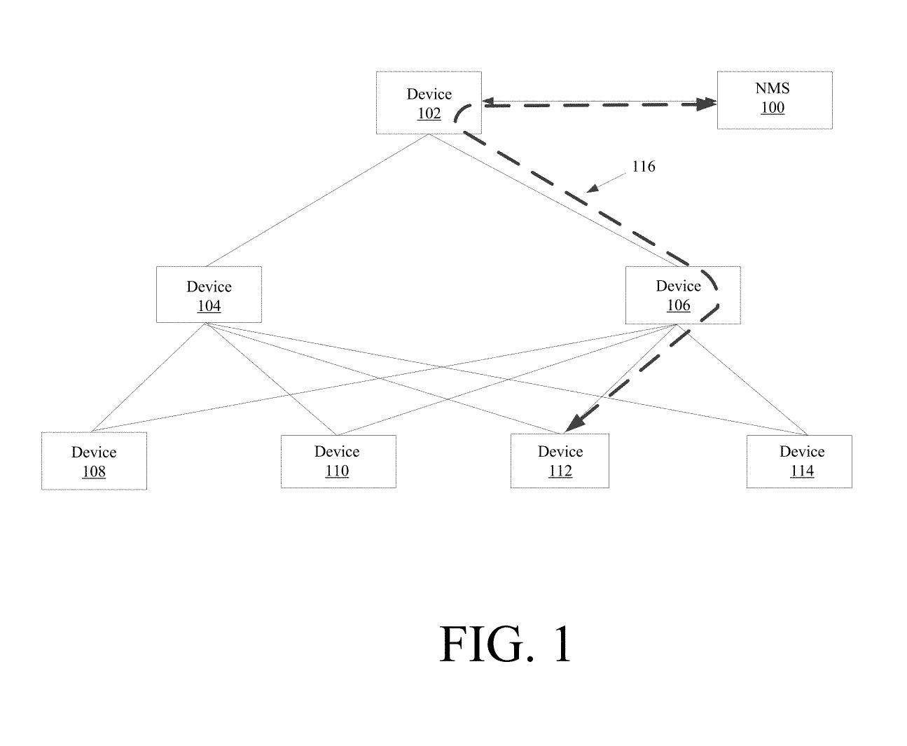

While many network configurations can be used, FIG. 1 illustrates an example embodiment of an aggregation of network devices that determines one or more distributed health scores. In this particular embodiment, NMS 100 is connected and in communication with device 102, which is in turn connected to and in communication with devices 104 and 106. Devices 108, 110, 112, and 114 are in communication with both devices 104 and 106. Accordingly, assuming all the devices on this network configuration are adequately functioning, communication path 116, such as a path defined by a pre-existing routing protocol, establishes communication between device 112 and device 106, device 106 and device 102, and then between device 102 and NMS 100. However, it's important to note that while FIG. 1 shows one type of network, alternative embodiments can be done with any type of topology, such as a cluster, tree, mesh, and/or any other individual topology or combination of network topologies.

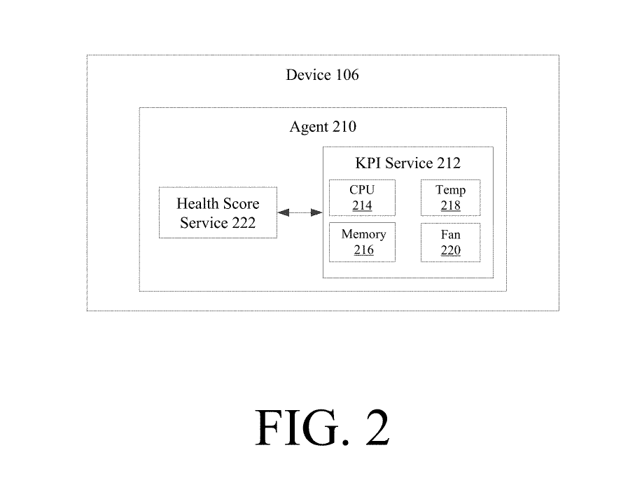

Each device on the network has its own health index or SHI. FIG. 2 illustrates an example embodiment of an agent executing on each of the network devices on a network. Agent 210 monitors and/or determines its respective device's SHI. For example, agent 210 executes on device 106 and includes KPI service 212. KPIs are defined and/or programmed into KPI service 212, which can include, but is not limited to, one or more KPIs related to CPU 214, memory utilization 216, temperature 218, and/or fan status 220. Any number of KPIs can be defined and/or programmed, and the set of KPIs may be particular to device 106. For example, since device 106 may be a router, switch, server, etc., the KPIs in KPI service 212 may vary based on the type of device. The set of KPIs for a server, for instance, may be different than the set of KPIs for a switch.

The health score or SHI of device 106 is determined locally at the device. For example, health score service 222 calculates the SHI of device 106 in FIG. 2 by receiving KPI values communicated from KPI service 212. The KPIs, either the entirety or a subset/combination of them on device 106, then determines device 106's SHI, which can then be communicated and/or shared with any other device on the network communicatively coupled with device 106.

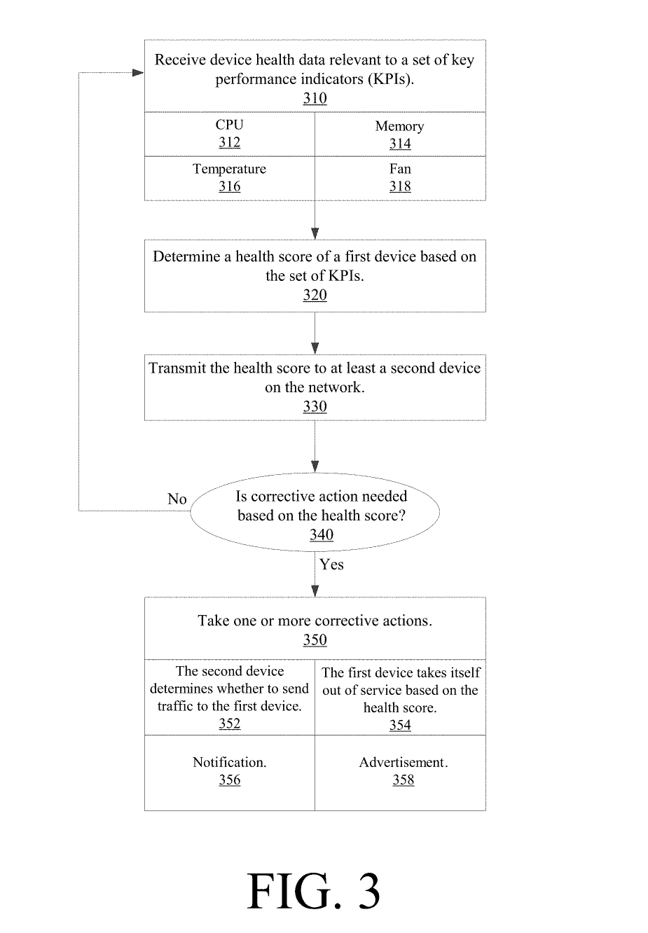

FIG. 3 illustrates a flow chart of a method of determining a distributed health score based on the KPIs. KPI service 212, for example, can receive device 106's health data relevant to a set of KPIs (step 310). As discussed above, any number and/or combination of KPIs can be within the set. For example, an embodiment may define a set of 25 KPIs for device 106, which includes, but is not limited to, KPIs relating to CPU usage (step 312), memory utilization (step 314), temperature or overheating of any device component(s) (step 316), and fan status (e.g., fan fails to operate, is unresponsive, etc. (step 318).

The SHI of device 106 is determined based on the set of KPIs (step 320). The SHI, for example, can consist of a combination of reported KPI values. Thus, the KPI values, in combination, can be used to define the numeric value of the overall SHI score. Health score service 222 in FIG. 2, for instance, can receive from KPI service 212 the KPI output, define what KPIs are used in the score calculation, how many KPIs are used in the calculation, etc. For example, in an embodiment, health score service 22 defines a set of 25 KPIs for device 106, each of the KPIs given equal priority in the overall SHI calculation. Each device, including device 106, starts with an overall SHI score of 100. Thus, each KPI value reported from KPI service 212 contributes a value of 4 to the overall SHI (KPI=100/25). If one or more KPIs report a null value due to device failures, health score service 222 will calculate a score lower than 100 (e.g., SHI=92 for 2 KPI null values).

In some embodiments, the SHI is determined based on one or more thresholds associated with the set of KPIs within the calculation. For example, CPU KPI 214 can have a threshold of 80%, memory KPI 216 a threshold of 80%, temperature KPI 218 a threshold of 100 degrees F., and power supply KPI a threshold of 1. When a KPI fails to be within an acceptable threshold (say, temperature KPI 218 determines the device's temperature is over 110 degrees F.), then that KPI is set to 0 and lowers the overall SHI score.

The SHI score can have one or more overall thresholds itself. In an embodiment in which the SHI consists of a combination of a CPU KPI 214, memory KPI 216, temperature KPI 218, and power supply KPI, all prioritized equally (e.g., for an SHI starting score of 100, each respective KPI contributes 25), the SHI score can have a threshold of 75. Thus, an overall score of 75 or less means device 106 is in a degraded state and/or is otherwise indicating less than optimal operating conditions. Accordingly, if device 106 is operating at:

CPU=30% (KPI=25)

Memory=10% (KPI=25)

Temperature=88 F (KPI=25)

Power Supply=½ (KPI=0)

The corresponding SHI, which in this example is the summed value of the KPIs, has a value of 75. Since an SHI of 75 is less than the threshold, device 106 is determined to be in a degraded state.

Moreover, more than one threshold may be used for the individual KPIs, the SHI, or both. For example, temperature KPI 218 may have a first threshold at 100 F (e.g., temperatures above 100 F sets the KPI =0) and a second threshold of 90-100 F. The KPI may be some fraction of the full value when it lies within the second threshold (e.g., KPI =12). Depending on device and how nuanced the SHI calculation needs to be, any number of KPI and/or SHI thresholds may be used as appropriate. A first SHI threshold may indicate a degraded state, for example, while a second SHI threshold may indicate a warning state, etc.

In some embodiments, certain KPIs may be considered better predictors of device health than other KPIs. In this instance, the SHI can be based on one or more weighted thresholds associated with the set of KPIs, where the weighted thresholds are based on one or more attributes of the device. The KPIs can be weighted (e.g., low, medium, high) to ensure that more important KPIs affect the overall value of the SHI. The KPI weights can be set and/or configured around device 106 attributes like device priority, location priority, device component priority, etc. For example, CPU KPI 214 can have higher weight (higher priority) than fan speed KPI 220 (lower priority) in the SHI calculation.

Once the SHI is determined, device 106 can transmit, make available, and/or actively send the SHI to any other device connected to it on the network (step 330). At that point, it can be determined, locally or at a remote device, whether corrective action is needed based on the SHI (step 340). For instance, if the SHI is above a cutoff threshold, device 106 is determined to be operating at an acceptable level and no corrective action is needed. Device 106 then continues to monitor and determine its KPIs. However, if the SHI is below the cutoff threshold, one or more corrective actions may be taken (step 350).

The corrective action(s) can take several forms. The decision to send traffic or take a device offline, for example, can be determined locally or remotely. Where the decision is determined locally, device 106 can take a corrective action itself based on the health score (step 354). If the SHI of device 106 is below the cutoff threshold and/or otherwise indicates a degraded status, device 106 can take itself offline or put itself into a maintenance mode.

Alternatively, network/traffic decisions can be determined remotely when remote device 102 decides and/or takes the appropriate corrective action regarding device 106. For example, if the SHI sent by device 106 to device 102 is below the cutoff threshold and/or otherwise indicates a degraded status, device 102 can determine that traffic should be sent to a device other than device 106 (e.g., traffic should be sent to device 104 instead) (step 352). More detailed discussions and specific embodiments on remote and local decisions is included in the later discussion.

Other corrective actions taken in response to the SHI being below the cutoff threshold and/or otherwise indicating a degraded status can be, but are not limited to, notifications (step 356) and/or advertisements (step 358). A notification is a triggered message without active exchange, such as device 106, without transmitting or communicating the SHI to remote device 102, sending information or a notification to the network management system that it is in a degraded state and/or is offline. By contrast, an advertisement is a protocol exchange between network devices, such as informing the local switch, remote switch, or both that the device is in a degraded state and/or is offline. For example, based on the SHI, device 106 can send information using a routing protocol to remote device 102 indicating that a specific network is reachable, and what the next “hop” or IP address is to use to get to the final destination. The advertisement may or may not send the SHI to remote device 102 as well as the advertisement.

Accordingly, for a locally calculated SHI, any appropriate combination of local decision, remote decision, notification, and/or advertisement is contemplated within the scope of the invention. The following describes a non-exhaustive list of corrective actions that can be taken:

local decision

remote decision

notification and remote decision

notification only

advertisement, notification, and remote decision

advertisement and notification only

In the case where device 106 takes a corrective action itself (step 354), device 106 can take itself offline. For example, device 106 may put itself into a maintenance mode, where it ceases to receive and/or initiate communications from other devices on the network until it has determined or is told that it no longer needs maintenance. Device 106 can also send an indicator to other devices on the network, where the indicator informs the other devices that device 106 is degraded and is no longer receiving or soliciting traffic.

In the case where one or more other devices on the network take the corrective action (step 352), the other devices on the network can take device 106 offline based on the SHI they've received. Thus, a remote device can trigger a corrective action when it understands the received SHI from device 106 and has a corresponding corrective action attached for device 106. The remote devices, for example, can stop sending or expecting traffic from device 106 when the SHI, and/or even one or more KPIs, drops below its associated threshold. Thus, if device 112 usually sends traffic to device 106 and then receives a degraded SHI value from device 106, device 112 can begin to send traffic to another device with an acceptable SHI value.

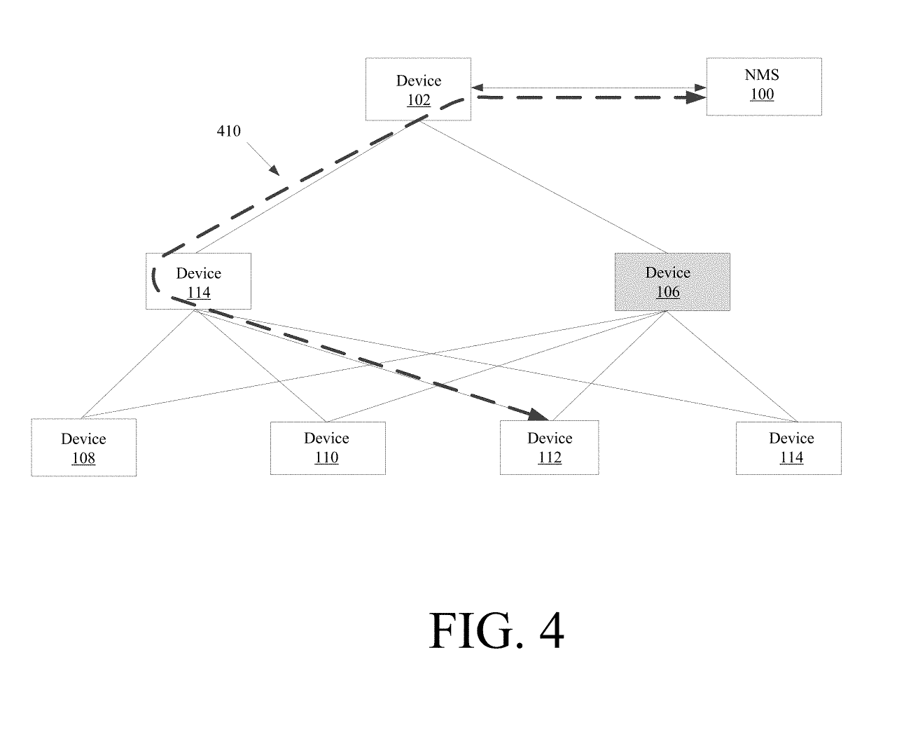

FIG. 4 illustrates an example embodiment of taking device 106 offline. Regardless of whether device 106 takes itself offline or other devices on the network take device 106 offline, traffic is re-routed to reflect device 106's absence on the network. In the example shown, traffic from device 112 is re-routed to device 114, creating communication path 410. Device 106 is free to be repaired, modified, maintained, etc. in a way that doesn't affect other devices on the network, including network traffic.

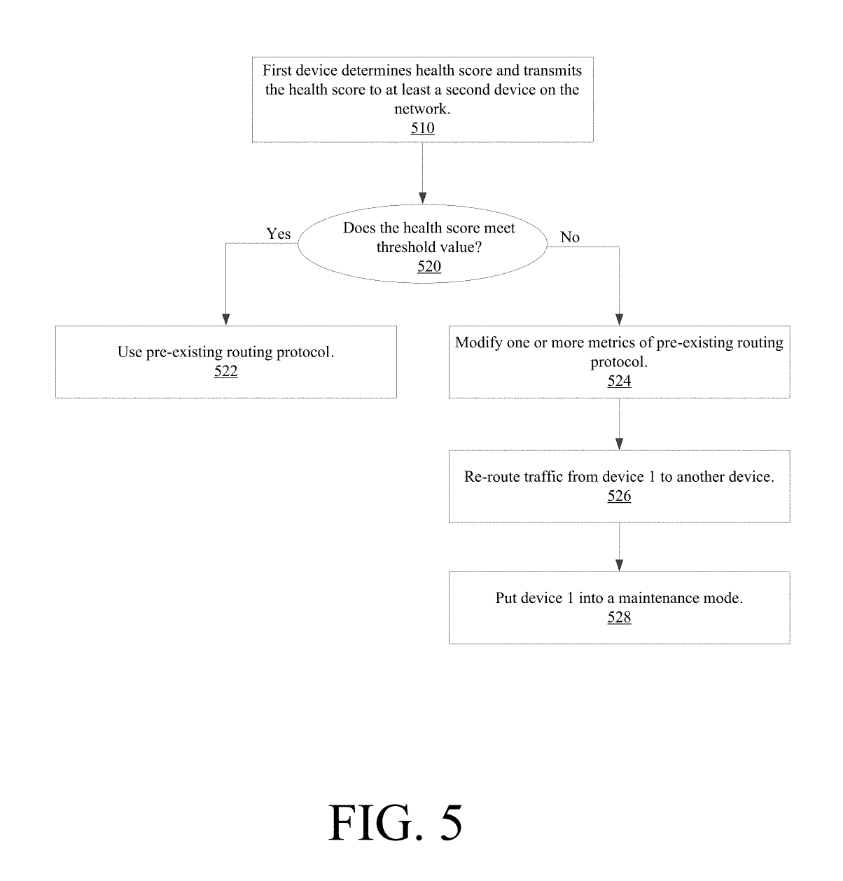

FIG. 5 shows a flow chart illustrating a method of such a corrective action. In embodiments, device 106 determines its SHI and transmits the SHI to other devices on the network (step 510). If the SHI meets its respective threshold value (step 520), then device 106 and/or the network continues to use a pre-existing routing protocol to send traffic to device 106 and other devices on the network (step 522). However, if the SHI fails to meet its respective threshold value (step 520), then device 106 is taken offline and traffic on the network needs to be adjusted.

For example, in some embodiments, device 106 can take itself offline. In this instance, device 106 can communicate its offline status to other devices on the network in communication with it, and those devices will then avoid sending traffic to device 106.

In other embodiments, however, any upstream device that receives device 106's SHI can determine whether to continue to send traffic to device 106. Device 102, for example, can receive the SHI from a number of devices on the network, the SHI being comprised of an overall health score, a combination of a set of key performance indicators, or both for each respective device. Suppose device 106 is a downstream device that sends its SHI to device 102. Device 102 can then determine whether to send network traffic to device 106 based on its SHI in relation to one or more thresholds.

For instance, device 102 can determine whether to send traffic to device 106 based on a couple of set SHI thresholds. For example, if the SHI of device 106 is above a first threshold (e.g., SHI>95) that indicates a high state of health, then device 102 can continue to send traffic to the first device in accordance with a pre-existing routing protocol.

However, if the SHI is above a second threshold (e.g., SHI>75) but below the first threshold (SHI<95), then device 102 can weight one or more routing metrics in its determination of whether to send traffic to device 106. The routing metrics can be a weighted sum based on anything related to any type of routing decision. For example, a routing metric can be related to session capacity, with session capacity being one of the most important factors in the routing protocol. In this instance, the metric corresponding to session capacity would be weighted higher than other metrics, such that devices with high session capacity are more likely to be chosen regardless, or in spite of, having a low SHI score. Thus, if device 106 has a low SHI score, but a high session capacity compared to other downstream devices, then device 102 may continue to send traffic to device 106 since the session capacity metric affects the overall routing determination more than the other routing metrics. Conversely, if device 102 can choose from other downstream devices with high SHI scores with session capacities similar to device 106, then device 102 will choose to send traffic to those devices instead of device 106.

Device 102 can modify one or more metrics of the pre-existing routing protocol to reflect device 106's degraded status (step 524) in order to re-route traffic when device 102 chooses another downstream device. This modified routing protocol re-routes traffic from device 106 to another chosen device that can handle the traffic (step 526), and does so without interrupting traffic flow on the system. Additionally and/or alternatively, in response to being informed from device 102 that device 102 will no longer send traffic to it, device 106 can put itself into a maintenance mode or can otherwise be flagged for attention, either flagged by itself or device 102 (step 528).

In further embodiments, if the SHI of device 106 is below the second threshold (e.g., SHI is lower than 75), the health of device 106 can be seen as far too degraded. Device 106 is then automatically taken out of the routing table in the routing protocol, and traffic is sent to another device.

In some embodiments, device 106 itself can determine a trend in its SHI. If the trend indicates a decline in its health, for example, device 106 can send a warning indicator to another device or to a system administrator. A declining health trend can also be sufficient for device 106 to take itself offline, especially if the rate of the decline is rapid or rapidly increasing. One or more thresholds of the rate of change the SHI can, therefore, also be used by device 106 to determine if it needs to take itself offline or put itself into a maintenance mode.

Thus, the locally determined SHI values, along with an individual device's intelligence to make dynamic routing decisions based on the SHI values (the device itself or another device on the network), allows for a distributed health score calculation that breaks network dependencies on NMS 100 or any one device on the network. Moreover, the SHIs described throughout remove dependencies on connectivity, network disruption, and/or increases the reliability of network health determinations compared to standard pull and push based models. Devices can then be repaired more quickly and more accurately than other health monitoring models.

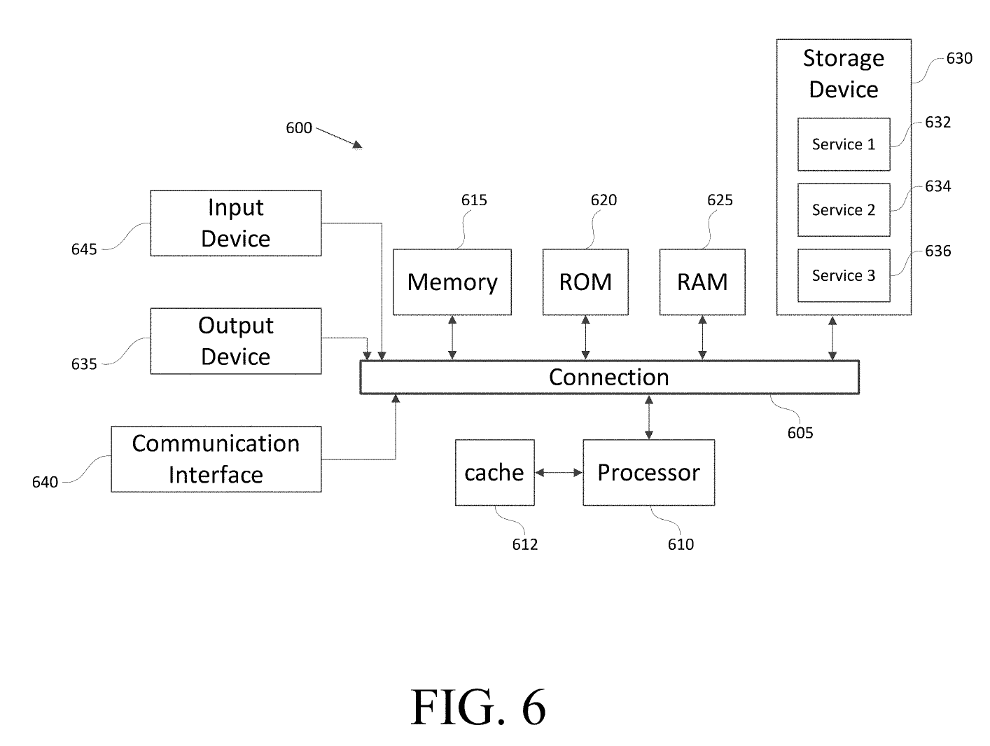

FIG. 6 shows an example of computing system 600 that can be used in combination with the embodiments discussed above. For example, computing system 600 can represent any of FIG. 1, 2, or 4, or a combination of such devices. In computing system 600 the components of the system are in communication with each other using connection 605. Connection 605 can be a physical connection via a bus, or a direct connection into processor 610, such as in a chipset architecture. Connection 605 can also be a virtual connection, networked connection, or logical connection.

In some embodiments computing system 600 is a distributed system in which the functions described in this disclosure can be distributed within a datacenter, multiple datacenters, a peer network, etc. In some embodiments, one or more of the described system components represents many such components each performing some or all of the function for which the component is described. In some embodiments, the components can be physical or virtual devices.

Example system 600 includes at least one processing unit (CPU or processor) 610 and connection 605 that couples various system components including system memory 615, such as read only memory (ROM) and random access memory (RAM) to processor 610. Computing system 600 can include a cache of high-speed memory connected directly with, in close proximity to, or integrated as part of processor 610.

Processor 610 can include any general purpose processor and a hardware service or software service, such as services 632, 634, and 636 stored in storage device 630, configured to control processor 610 as well as a special-purpose processor where software instructions are incorporated into the actual processor design. Processor 610 may essentially be a completely self-contained computing system, containing multiple cores or processors, a bus, memory controller, cache, etc. A multi-core processor may be symmetric or asymmetric.

To enable user interaction, computing system 600 includes an input device 645, which can represent any number of input mechanisms, such as a microphone for speech, a touch-sensitive screen for gesture or graphical input, keyboard, mouse, motion input, speech, etc. Computing system 600 can also include output device 635, which can be one or more of a number of output mechanisms known to those of skill in the art. In some instances, multimodal systems can enable a user to provide multiple types of input/output to communicate with computing system 600. Computing system 600 can include communications interface 640, which can generally govern and manage the user input and system output. There is no restriction on operating on any particular hardware arrangement and therefore the basic features here may easily be substituted for improved hardware or firmware arrangements as they are developed.

Storage device 630 can be a non-volatile memory device and can be a hard disk or other types of computer readable media which can store data that are accessible by a computer, such as magnetic cassettes, flash memory cards, solid state memory devices, digital versatile disks, cartridges, random access memories (RAMs), read only memory (ROM), and/or some combination of these devices.

The storage device 630 can include software services, servers, services, etc., that when the code that defines such software is executed by the processor 610, it causes the system to perform a function. In some embodiments, a hardware service that performs a particular function can include the software component stored in a computer-readable medium in connection with the necessary hardware components, such as processor 610, connection 605, output device 635, etc., to carry out the function.

For clarity of explanation, in some instances the present technology may be presented as including individual functional blocks including functional blocks comprising devices, device components, steps or routines in a method embodied in software, or combinations of hardware and software.

Any of the steps, operations, functions, or processes described herein may be performed or implemented by a combination of hardware and software services or services, alone or in combination with other devices. In some embodiments, a service can be software that resides in memory of a client device and/or one or more servers of a content management system and perform one or more functions when a processor executes the software associated with the service. In some embodiments, a service is a program, or a collection of programs that carry out a specific function. In some embodiments, a service can be considered a server. The memory can be a non-transitory computer-readable medium.

In some embodiments the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Methods according to the above-described examples can be implemented using computer-executable instructions that are stored or otherwise available from computer readable media. Such instructions can comprise, for example, instructions and data which cause or otherwise configure a general purpose computer, special purpose computer, or special purpose processing device to perform a certain function or group of functions. Portions of computer resources used can be accessible over a network. The computer executable instructions may be, for example, binaries, intermediate format instructions such as assembly language, firmware, or source code. Examples of computer-readable media that may be used to store instructions, information used, and/or information created during methods according to described examples include magnetic or optical disks, solid state memory devices, flash memory, USB devices provided with non-volatile memory, networked storage devices, and so on.

Devices implementing methods according to these disclosures can comprise hardware, firmware and/or software, and can take any of a variety of form factors. Typical examples of such form factors include servers, laptops, smart phones, small form factor personal computers, personal digital assistants, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are means for providing the functions described in these disclosures.

Although a variety of examples and other information was used to explain aspects within the scope of the appended claims, no limitation of the claims should be implied based on particular features or arrangements in such examples, as one of ordinary skill would be able to use these examples to derive a wide variety of implementations. Further and although some subject matter may have been described in language specific to examples of structural features and/or method steps, it is to be understood that the subject matter defined in the appended claims is not necessarily limited to these described features or acts. For example, such functionality can be distributed differently or performed in components other than those identified herein. Rather, the described features and steps are disclosed as examples of components of systems and methods within the scope of the appended claims.

What is claimed is:

1. A system for determining a distributed health score for an aggregation of network devices, the system comprising:
an agent executing on each of the network devices on a network, wherein a first agent on a first device is configured to:
receive device health data relevant to a set of key performance indicators;
determine a health score of the first device based at least in part on the set of key performance indicators; and
enable the determined health score to be made available to at least a second device on the network, wherein determining whether to take a corrective action associated with the first device is based on the determined health score.

2. The system of claim 1, wherein the health score of the first device is determined locally at the first device.

3. The system of claim 1, wherein the set of key performance indicators are particular to the first device.

4. The system of claim 1, wherein the health score of the first device is determined based on one or more thresholds associated with the set of key performance indicators, and wherein the corrective action is when the second device stops sending traffic to the first device when a respective key performance indicator drops below its associated threshold.

5. The system of claim 1, wherein the first device takes the corrective action based on the health score, the corrective action being taking the first device offline.

6. The system of claim 1, wherein the first device takes the corrective action based on the health score, the corrective action being putting the first device into a maintenance mode.

7. The system of claim 1, wherein the corrective action is a determination by the second device of whether to send network traffic to the first device, the determination including modifying one or more metrics of a preexisting routing protocol when the second device stops sending network traffic to the first device.

8. A method for determining a distributed health score for an aggregation of network devices, the method comprising:
receiving device health data relevant to a set of key performance indicators;
determining a health score of a first device based at least in part on the set of key performance indicators; and
enabling the determined health score to be made available to at least a second device on the network, wherein determining whether to take a corrective action associated with the first device is based on the determined health score.

9. The method of claim 8, further comprising:
determining a trend in the health score of the first device; and
in response to determining a trend indicating a decline in the health of the first device, taking the first device offline.

10. The method of claim 8, wherein determining the health score of the first device is based on one or more weighted thresholds associated with the set of key performance indicators, wherein the weighted thresholds are based on an attribute of the first device.

11. The method of claim 8, wherein the health score of the first device is determined locally at the first device.

12. The method of claim 8, wherein the set of key performance indicators are particular to the first device.

13. The method of claim 8, wherein determining the health score of the first device further comprises:
setting one or more thresholds associated with the set of key performance indicators; and
ceasing to send traffic to the first device when a respective key performance indicator drops below its associated threshold.

14. The method of claim 8, further comprising the corrective action based on the health score of the first device being the first device taking itself offline.

15. A non-transitory computer-readable medium containing instructions for determining a distributed health score for an aggregation of network devices that, when executed by one or more computer processors of an agent executing on each of the network devices on a network, cause the agent to:
receive device health data relevant to a set of key performance indicators;
determine a health score of a first device based at least in part on the set of key performance indicators; and
enable the determined health score to be made available to at least a second device on the network, wherein determining whether to take a corrective action associated with the first device is based on the determined health score.

16. The non-transitory computer-readable medium of claim 15, wherein the health score of the first device is determined locally at the first device.

17. The non-transitory computer-readable medium of claim 15, wherein the set of key performance indicators are particular to the first device.

18. The non-transitory computer-readable medium of claim 15, wherein the health score of the first device is determined based on one or more thresholds associated with the set of key performance indicators, and wherein the corrective action is when the second device stops sending traffic to the first device when a respective key performance indicator drops below its associated threshold.

19. The non-transitory computer-readable medium of claim 15, wherein the first device takes the corrective action based on the health score, the corrective action being taking the first device offline.

20. The non-transitory computer-readable medium of claim 15, wherein the first device takes the corrective action based on the health score, the corrective action being putting the first device into a maintenance mode.
